(19) United States
(12) Patent Application Publication
(10) Pub. No.: US 2005/0058435 A1
(43) Pub. Date: Mar. 17, 2005

(54) Information storage medium for storing information for downloading text subtitles, and method and apparatus for reproducing the subtitles

(75) Inventors: Hyun-kwon Chung, Seoul (KR); Seong-jin Moon, Suwon-si (KR); Sung-wook Park, Seoul (KR); Kil-soo Jung, Hwaseong-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-Si (KR)

(21) Appl. No.: 10/901,448

(22) Filed: Jul. 29, 2004

Related U.S. Application Data
(60) Provisional application No. 60/492,332, filed on Aug. 5, 2003.

(30) Foreign Application Priority Data
Sep. 9, 2003 (KR) 2003-63354

(51) Int. Cl. H04N 5/781

(52) U.S. Cl. 386/95; 386/125

(57) ABSTRACT

An information storage medium stores information required to download text-based subtitles, and a method and apparatus for reproducing the subtitles, includes subtitle data information or location information thereof. Based on the stored information, subtitle and video mapping information regarding a linkage relation between text-based subtitle and multi-story video data, subtitle data information regarding the subtitles and reproduction time when the subtitles are displayed on a screen, and/or multi-lingual subtitle indication information that indicates subtitle and video mapping information according to languages so as to reproduce multi-lingual text-based subtitles are read from an information storage medium or via the Internet. Next, the read information are downloaded to a reproducing apparatus, and the text-based subtitles are reproduced to correspond to related video data.

### CROSS-REFERENCE TO RELATED APPLICATIONS

This application claims the priorities of U.S. Provisional Application No. 60/492,332, filed on Aug. 5, 2003 in the United States Patent and Trademark Office, and Korean Patent Application No. 2003-63354, filed on Sep. 9, 2003 in the Korean Intellectual Property Office, the disclosures of which are incorporated herein in their entirety by reference.

### BACKGROUND OF THE INVENTION

1. Field of the Invention

The present invention relates to an information storage medium storing information required to download text subtitles, and a method and apparatus for reproducing the subtitles, and more particularly, to an information storage medium storing information required to download subtitles corresponding to video data recorded to have multiple paths for reproduction, and a method and apparatus for reproducing the subtitles.

2. Description of the Related Art

Conventional text-based captioning techniques, such as those involving MICROSOFT Synchronized Accessible Media Interchange (SAMI) technology or REALNETWORKS Real-text technology, make a text subtitle file to be linked to video stream data, thereby allow a user to view subtitles with the streaming data.

As shown in FIG. 1, a reproducing decoder 100 reads video stream data 130 and subtitle data 140 and/or additional reproduction information 150 from a disc storage medium 110 or via the Internet 120, and displays the subtitle data 140 in a predetermined portion of a screen at a predetermined time while reproducing the video object stream data 130. In other words, when the video stream data 130 is recorded in a file format or recorded to have a single path for reproduction, a user can reproduce the subtitle data 140 during reproduction of the video stream data 130 on a display device 160 without difficulties. However, if the video stream data 130 is recorded in a Digital Versatile Disc (DVD)-video format where the reproduction path of a video stream data 130 can be changed during reproduction via a user interface 200 of FIG. 2, the subtitle data 140 cannot be displayed during the reproduction.

As shown in FIG. 2, a conventional subtitle structure recorded according to a time sequence is not applicable to a video data stream, such as DVD-video, that allows the reproduction path of a video stream to be changed during reproduction via the user interface 200, such as to select from a menu between playing the entire video or between selected scenes.

### SUMMARY OF THE INVENTION

An aspect of the present invention provides an information storage medium that stores multi-story video data recorded to have multiple reproduction paths and information required to download text-based subtitles, and a method and apparatus for downloading the information from the information storage medium or according to user input and reproducing the subtitles.

An aspect of the present invention also provides an information storage medium that stores information required to download text-based subtitles, and a method and apparatus for reproducing multi-lingual subtitles corresponding to video stream data that is recorded to have multiple reproduction paths so that the reproduction path of a video stream can be changed via user interface.

An aspect of the present invention also provides an information storage medium that stores information required to download text-based subtitles, and a method and apparatus for reproducing subtitles that a movie manufacturer provides via the Internet based on the information read from the information storage medium.

According to one aspect of the present invention, there is provided an information storage medium that stores multi-story video data recorded to have multiple paths for reproduction, the information storage medium comprising subtitle information and/or location information of the subtitle information linked to the multi-story video data corresponding to the multiple paths for reproduction.

An aspect of the subtitle information is read at a location specified in the location information determined by a user so as to allow the user to select subtitles that are to be reproduced, prior to reproduction of the multi-story video data.

According to another aspect of the present invention, there is provided an information storage medium that stores multi-story video data recorded to have multiple paths for reproduction, the information storage medium comprising commands for subtitle processing, the commands instructing selection of a language of subtitles corresponding to a multi-story video data, and wherein during reproduction of the multi-story video data, the commands are executed to read subtitle information and allow a user to select subtitles.

According to yet another aspect of the present invention, there is provided an information storage medium that stores multi-story video data recorded to have multiple paths for reproduction, comprising subtitle information and/or location information of the subtitle information linked to the multi-story video data corresponding to the multiple paths for reproduction.

According to still another aspect of the present invention, there is provided an information storage medium that stores multi-story video data recorded to have multiple paths for reproduction, the information storage medium comprising multi-lingual subtitle indication information supporting multiple languages; subtitle data information; subtitle and video mapping information specifying linkage relations between text-based subtitles and multi-story video data corresponding to the multiple paths for reproduction; and a command instructing location information of the multi-lingual subtitle indication information to be parsed so as to read the multi-lingual subtitle indication information and the subtitle and video mapping information in a reproducing apparatus.

An aspect of the information storage medium further includes command data instructing the multi-lingual subtitle indication information to be parsed, a user to select subtitles, the subtitle and video mapping information related to the selected subtitles to be parsed, and the selected subtitles to be output.

An aspect of the information storage medium further includes command data instructing the multi-lingual subtitle indication information to be parsed so as to obtain subtitle selection information, the subtitle and video mapping information to be selected based on the subtitle selection information, and the subtitle data information to be read and output.

An aspect of the information storage medium further includes command data instructing the selected subtitle data to be mapped to the video data, and the subtitle data information to be read and output.

According to still another aspect of the present invention, there is provided a method of reproducing subtitle data linked to video data using a reproducing apparatus that reproduces multi-story video data recorded to have multiple paths for reproduction from an information storage medium, the method comprising reading subtitle information at a location prior to reproduction of the multi-story video data, information of the location being provided by a user; and allowing the user to select desired subtitles to be reproduced based on the read subtitle information.

According to still another aspect of the present invention, there is provided a method of reproducing subtitle data linked to video data, using a reproducing apparatus that reproduces multi-story video data recorded to have multiple paths for reproduction from an information storage medium that further stores commands for subtitle processing, the method comprising reading subtitle information when the commands are executed during reproduction of the multi-story video data; and allowing a user to select subtitles based on the read subtitle information.

According to still another aspect of the present invention, there is provided a method of reproducing subtitle data linked to video data, using a reproducing apparatus that reproduces multi-story video data with multiple paths for reproduction from an information storage medium that further stores subtitle information and/or location information of the subtitle information, the method comprising detecting a location where the subtitle information is stored and reading the subtitle information in the reproducing apparatus; and selecting a subtitle language based on the parsed subtitle information.

According to still another aspect of the present invention, there is provided a method of reproducing subtitle data linked to video data stored in an information storage medium that stores multi-story video data recorded to have multiple paths for reproduction, the method comprising reading multi-lingual subtitle indication information and analyzing types of languages and applications of subtitles; parsing subtitle and video mapping information that specifies a linkage relation between the subtitles and the video data, and reading subtitle data information that is to be reproduced; and outputting the subtitle data information corresponding to the video data during reproduction of the video data.

According to still another aspect of the present invention, there is provided an apparatus for reproducing multi-story video data recorded to have multiple paths for reproduction from an information storage medium, the apparatus comprising a reader reading audio/video (AV) data, text-based subtitle data information, multi-lingual subtitle indication information, and/or downloaded font data indicated in subtitle and video mapping information from the information storage medium; a decoder decoding the AV data to output a moving image; a subtitle processor processing a language selection file related to the subtitle data information and subtitle and video mapping information, and performing screen rendering; a menu generator generating a menu according to command data read by the reader or as predetermined; and a blender combining the moving image output from the decoder, the subtitle data output from the subtitle processor, and/or the menu generated by the menu generator, and displaying a result of combination on a display device.

Additional aspects and/or advantages of the invention will be set forth in part in the description which follows and, in part, will be obvious from the description, or may be learned by practice of the invention.

### BRIEF DESCRIPTION OF THE DRAWINGS

The above and/or other aspects and advantages of the present invention will become more apparent and more readily appreciated by describing in detail exemplary embodiments thereof with reference to the accompanying drawings in which:

FIG. 1 is a diagram illustrating a conventional method of displaying text-based subtitles;

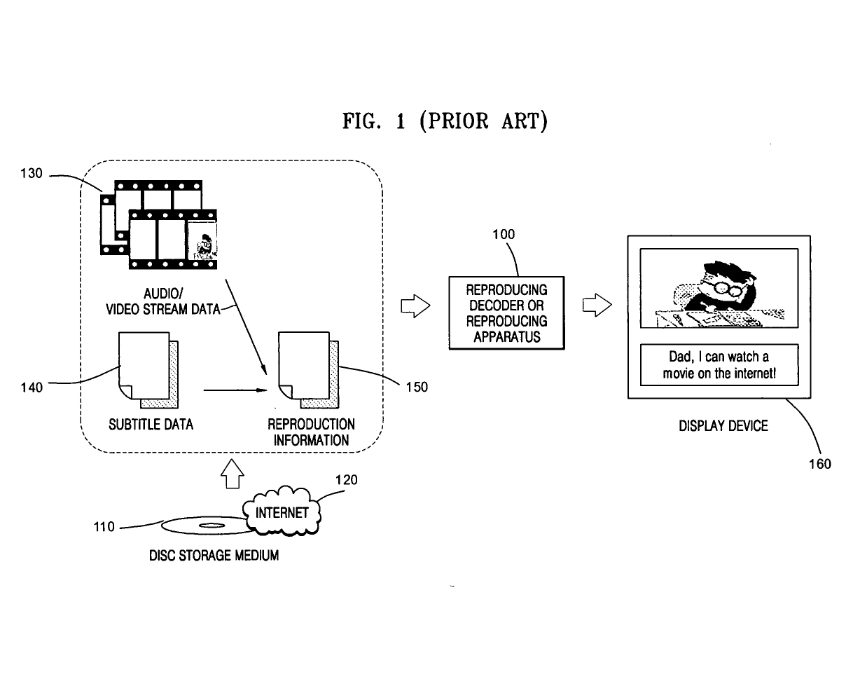

FIG. 2 is a diagram illustrating a conventional method of changing the reproduction path of a video stream during reproduction of DVD-video via a user interface;

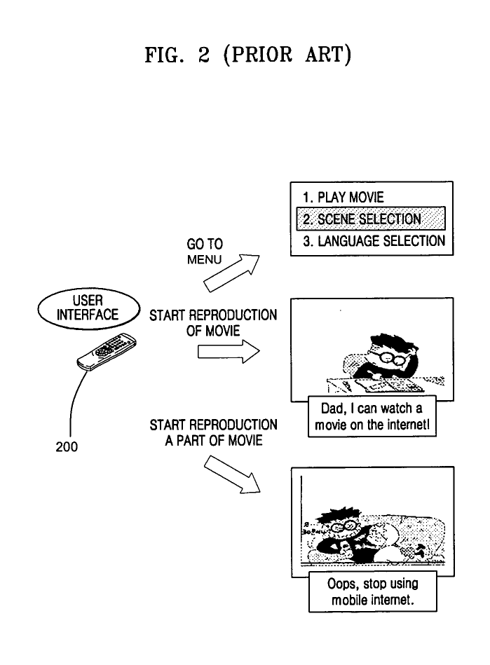

FIG. 3 is a block diagram of a recording and/or reproducing apparatus according to an embodiment of the present invention;

FIGS. 4A and 4B are diagrams illustrating methods of detecting subtitle information according to embodiments of the present invention;

FIG. 5 is a diagram illustrating a method of detecting subtitle information according to yet another embodiment of the present invention;

FIG. 6 is a diagram illustrating a method of detecting subtitle information according to still another embodiment of the present invention;

FIG. 7 is a flowchart illustrating a method of reproducing subtitle data according to an embodiment of the present invention;

FIG. 8 is a diagram illustrating a structure of text-based subtitles according to an embodiment of the present invention;

FIG. 9 illustrates a structure of subtitle and video mapping information for the text-based subtitles of FIG. 8, according to an embodiment of the present invention;

FIG. 10 illustrates a structure of multi-lingual subtitle indication information that contains the subtitle and video mapping data structure of FIG. 9, according to an embodiment of the present invention; and

FIG. 11 illustrates a structure of subtitle data shown in FIG. 9 or FIG. 10 according to an embodiment of the present invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

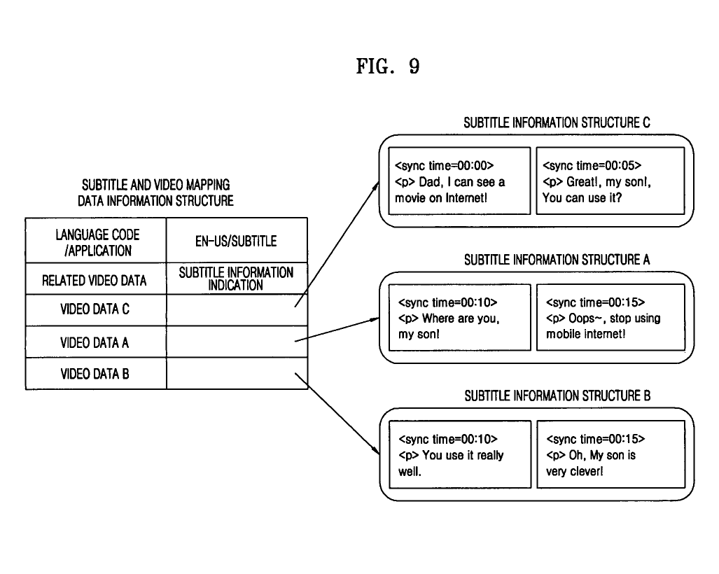

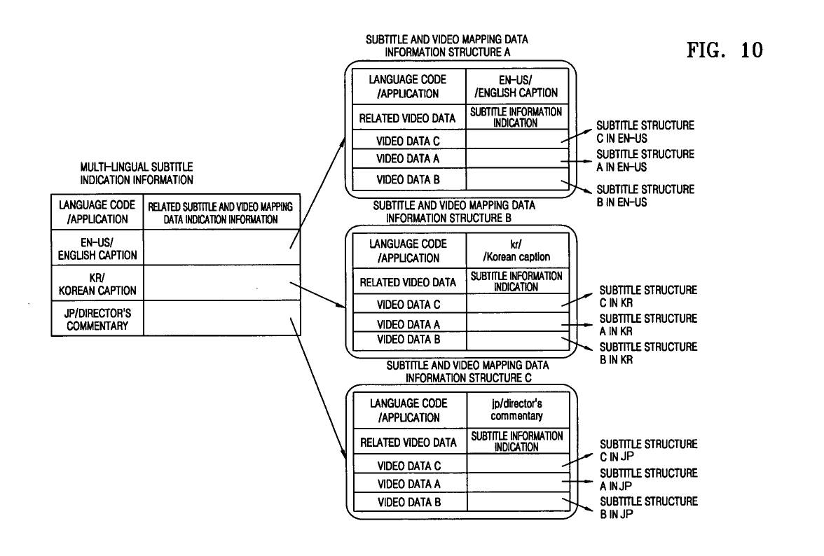

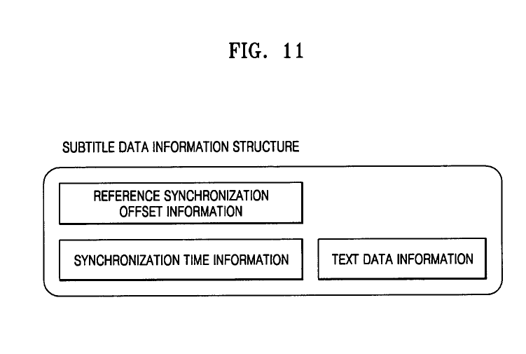

Aspects of the present invention suggest a technique of reading, from an information storage medium such as a disc or via the Internet, subtitle and video mapping information shown in FIG. 9 that specifies a relationship among text-based subtitles and a series of video data, subtitle data information shown in FIG. 11 that specifies the text-based subtitles and reproduction times when the subtitles are displayed on a screen, and multi-lingual subtitle indication information shown in FIG. 10 that specifies mapping relationships between subtitles in multiple languages and their related subtitle and video mapping information; downloading these information to a buffer memory of a reproducing apparatus; and reproducing the text-based subtitles to correspond to their related video that are being reproduced. The structures of the subtitles, the subtitle and video mapping information, the subtitle data information, and the multi-lingual subtitle indication information will be later described in great detail.

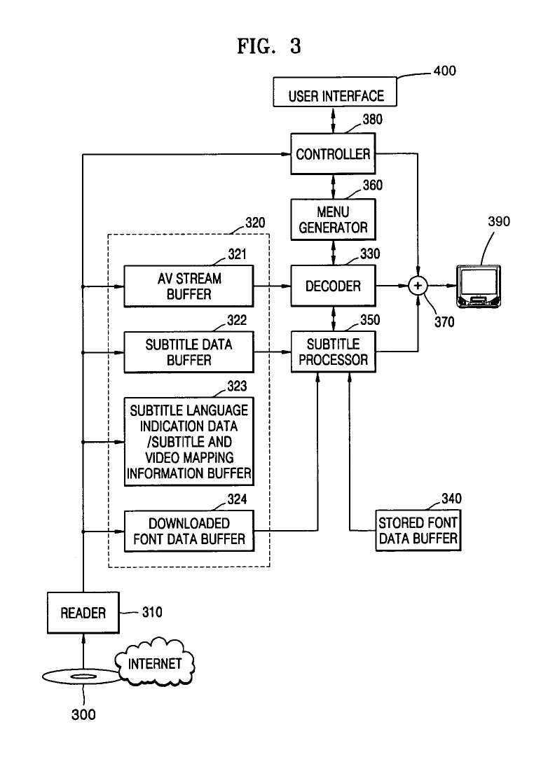

FIG. 3 is a block diagram of a reproducing apparatus according to an embodiment of the present invention. The reproducing apparatus of FIG. 3 includes a reader 310, a decoder 330, a subtitle processor 350, a menu generator 360, a blender 370, and a controller 380. The reader 310 reads audio/video (AV) data, text-based subtitle data information, multi-lingual subtitle indication information and/or subtitle and video mapping information, and/or downloaded font data indicated by the subtitle and video mapping information, from an information storage medium 300 such as a disc or via the Internet. The shown decoder 330, which is a type of Digital Versatile Disc (DVD) video decoder, decodes the AV data. However, it is understood that other types of decoders can be used, and that the medium 300 need not be a DVD in all aspects.

The subtitle processor 350 processes a language selection file related to subtitle data, and the subtitle and video mapping information and performs screen rendering. The menu generator 360 generates a menu in response to command data read by the reader 310 or as predetermined. The blender 370 combines a moving image output from the decoder 330, subtitle data output from the subtitle processor 350, and/or the menu generated by the menu generator 360, and displays a result of combination on a display device 390. The controller 380 allows a desired language to be selected from the menu generated by the menu generator 360 via a user interface 400, and controls the operations of the decoder 330, the subtitle processor 360, and the blender 370.

Also, the reproducing apparatus further includes a buffering unit 320 that buffers data exchanged among the reader 310, the decoder 330, and the subtitle processor 350, and stores selected font data; and a stored font data buffer unit 340 that stores resident font data that has been stored as a default. The buffering unit 220 includes an AV data buffer 321 that stores the AV stream data, a subtitle data buffer 322 that stores the subtitle data, a subtitle language indication data and/or subtitle and video mapping information buffer 323 that stores a subtitle language indication data and/or the subtitle and video mapping information, and a downloaded font data buffer 324 that stores the downloaded font data. While described as a reproducing apparatus, it is understood that the apparatus shown in FIG. 3 can further perform recording according to aspects of the invention.

In this disclosure, rendering indicates every possible process required to convert the text-based subtitle data into graphics data so that the text data can be displayed on the display device. For instance, rendering includes all of the processes required to detect a font that matches character codes of respective characters in the text data from the downloaded font data or the resident font data read from an information storage medium, convert the detected font into graphics, and display the graphics on the display device. However, it is understood that other terminology can be used to describe such an operation(s), and that the use of the rendering as a term is not otherwise limiting.

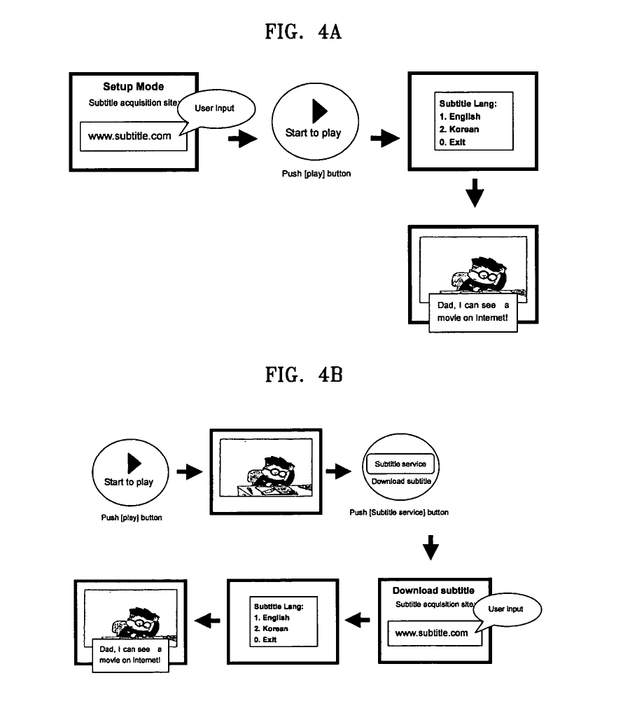

The reproducing apparatus according to the embodiment of FIG. 3 reads multi-lingual subtitle indication information, subtitle and video mapping information, and subtitle data information from an information storage medium such as a disc or via the Internet. FIGS. 4A and 4B illustrate embodiments of a method of detecting the subtitle information according to an aspect of the present invention. Referring to FIG. 4A, prior to reproduction of an AV stream, a reproducing apparatus reads information regarding respective subtitles at locations from an information storage medium or via the Internet as instructed by a user for every data reproduction, allows the user to select desired subtitles, and starts reproducing the AV stream together with the selected subtitles. The information regarding the locations may have been set in the reproducing apparatus by the user or manufacturer (i.e., as a default setting) or be input from the user for every data reproduction according to aspects of the invention.

Specifically, FIG. 4A illustrates a method of reading subtitle data information at a location (e.g., an address of a site on the Internet) where the subtitle data is stored. The method is performed using a user interface 400 and allows a user to select a subtitle language from a menu generated by the menu generator 360 of FIG. 3 in a setup mode, prior to AV reproduction. FIG. 4B illustrates a method of reading subtitle data information at a location set by a user, such as using a remote controller as the user interface 400, whenever reproduction of video data starts, and allowing the user to select a subtitle language from a menu generated by the menu generator 360. However, it is understood that the location can be otherwise set, such as through home networks or other such devices which transport data with respect to the reproducing apparatus. Moreover, it is understood that, instead of or in addition to an internet location as shown, the location can be another medium connected to the apparatus (such as a disk, memory stick, etc.), or a location on a local area network.

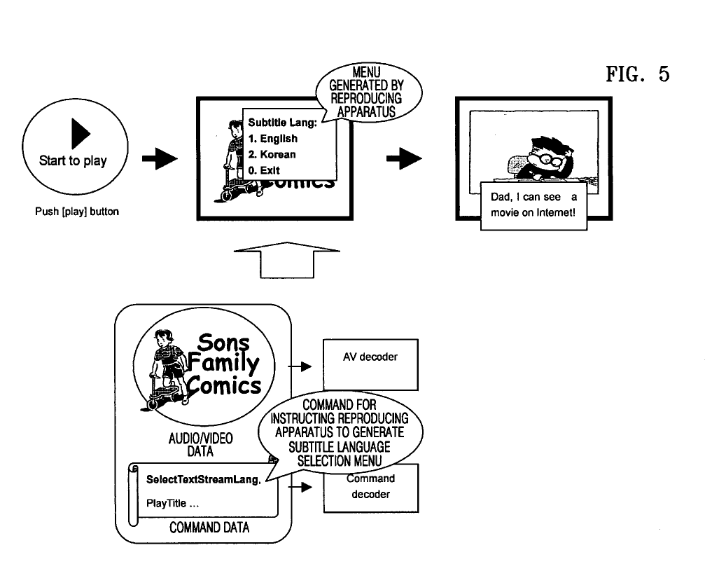

FIG. 5 illustrates a method of detecting subtitle data information according to yet another embodiment of the present invention. In the shown embodiment, commands for subtitle processing are stored in an information storage medium, and subtitle data information is detected and displayed during the AV stream reproduction.

More specifically, referring to FIG. 5, a movie content manufacturer includes commands that instruct a subtitle language to be selected from a menu as command data into AV data stored in the information storage medium. When command data that instructs the processing of the subtitles for the video object data that is being reproduced is stored in an AV decoder and a command decoder of the decoder 350 of FIG. 3, the command decoder sends the menu generator 360 a command that instructs the menu to be generated. Then, a user selects a subtitle language from the menu and subtitles in the selected language are selected. Here, the AV data includes information regarding PlayLists for data reproduction, video stream data, and Internet web document data.

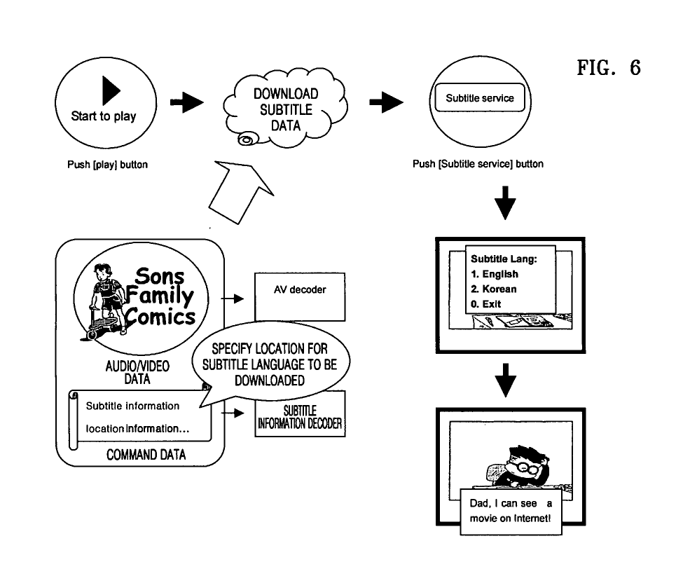

FIG. 6 illustrates a method of detecting subtitle data information according to yet another embodiment of the present invention. In the shown embodiment, location information regarding subtitles is stored in a particular position of an information storage medium, and the subtitles are read and reproduced at a location specified in the location information. More specifically, a movie content manufacturer stores the subtitle data information or location information thereof in the information storage medium. A reproducing apparatus detects the location of the subtitle data information based on the location information and reads and parses subtitle information in the buffering unit 320 of FIG. 3. When a user presses a button of an input device 400, such as a remote controller, or executes commands stored in the information storage medium or according to a predetermined sequence of processes set in the information storage medium, the menu generator 360 of the reproducing apparatus generates a menu for selection of a subtitle language and requests a user to select a desired subtitle language. Next, when a subtitle language is selected by the user or automatically selected as predetermined by the user, subtitles are displayed in the selected language during reproduction of the AV data. The location information includes at least one of multi-lingual subtitle indication information and subtitle and video mapping information, and specifies the location of the subtitle information.

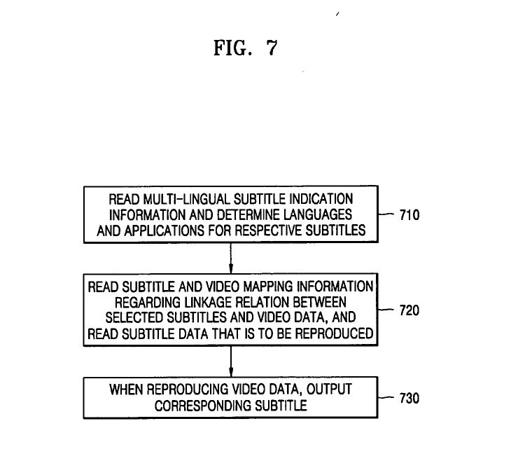

Also, according to the shown embodiment, the movie content manufacturer makes the commands that instruct the menu to be generated as command data and includes the command data into the AV stream stored in the information storage medium. When command data for subtitle processing is executed during the reproduction of the AV stream, the reproducing apparatus allows the user to select a subtitle language and reproduces the subtitles in the selected language. The AV stream includes information regarding PlayLists for data reproduction, video stream data, and Internet web document data. The commands are related to operations performed in a method of FIG. 7.

FIG. 7 is a flowchart illustrating a method of reproducing subtitle data according to an embodiment of the present invention. The method of FIG. 7 includes reading multi-lingual subtitle indication information to determine the types of subtitle languages and applications of subtitles (operation 710), detecting subtitle and video mapping information that specifies the mapping relation between the subtitles and corresponding video stream data and reading the subtitles that is to be reproduced (operation 720), and outputting the subtitles corresponding to the video stream data reproduced (operation 730).

Examples of commands related to the respective operations of this method will now be described. However, it is understood that other commands and command names can be used.

Bool QueryTextSubtitleInfo(uri) is a command that instructs the reproducing apparatus to perform operation 710. When the Bool QueryTextSubtitleInfo(uri) command is executed, multi-lingual subtitle indication information and subtitle and video mapping information are read in the reproducing apparatus before data reproduction and are read in based on location information of multi-lingual subtitle indication information, designated by an address of a site on the Internet such as a Uniform Resource Identifier (URI). That is, this command instructs the subtitle information to be downloaded before data reproduction without executing a menu for selection of a subtitle language.

Bool SelectTextSubtitleLang(uri) is a command that instructs the reproducing apparatus, after operation 710, to parse the multi-lingual subtitle indication information so that the menu generated by the reproducing apparatus; operation 720 to be performed according to the type of the selected subtitle language when the user selects the subtitle language from the menu; and operation 730 to be performed. That is, the menu is presented when the multi-lingual subtitle indication information and/or the subtitle and video mapping information are downloaded. Otherwise, the multi-lingual subtitle indication information and/or the subtitle and video mapping information are downloaded and the desired subtitle language is selected from the menu.

Bool SelectTextSubtitle(subtitle_id) is a command that instructs the reproduction system, after operation 710, to parse the multi-lingual subtitle indication information to obtain subtitle selection information subtitle_id; operation 720 to be performed on subtitles selected based on subtitle selection information subtitle_id, and operation 730 to be performed. That is, this command instructs a subtitle language to be selected based on the downloaded multi-lingual subtitle indication information and/or the subtitle and video mapping information without presenting the menu.

Bool BindTextSubtitle(video_map,subtitle_uri) is a command that instructs subtitle data indicated in information subtitle_uri to be mapped to video data based on information video_map, and operation 730 to be performed on the mapped subtitle data and the video data. That is, this command instructs the subtitle data to be linked to the video data without the multi-lingual subtitle indication information and/or the subtitle and video mapping information.

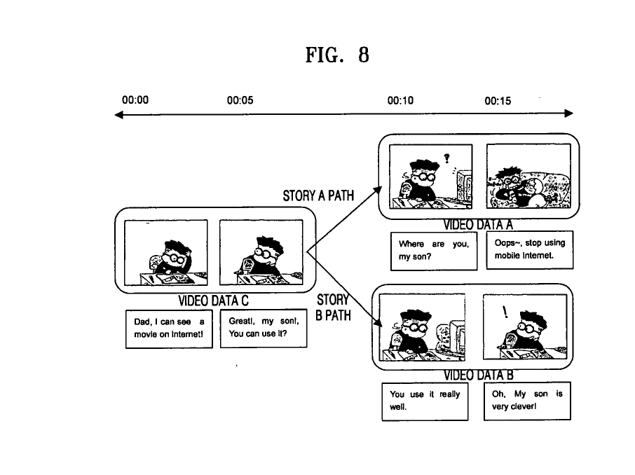

FIG. 8 is a diagram illustrating a structure of text-based subtitles according to an embodiment of the present invention. Referring to FIG. 8, multi-story video data is recorded to have multiple paths A and B for reproduction on an information storage medium installed in or separated from a reproducing apparatus. Also, the subtitle and the video mapping information that specifies a linkage relation between text-based subtitles and a series of video data, and text-based subtitle information regarding respective subtitles are recorded on the information storage medium. The multi-story video data is read and reproduced by the reproducing apparatus based on the subtitle and video mapping information and the text-based subtitle information. As shown in FIG. 8, after viewing video data C, two stories A, B, can be alternately chosen for display at time 00:10. Using the subtitle and video mapping information, different subtitles are shown for story A and story B paths. The information storage medium which is separated from the reproducing apparatus may be a memory card, a location in the Internet or other such medium which is connectable to the reproducing apparatus and from which data is retrieved. Additionally, it is understood that stories A and B do not need to be alternate scenes displayed at the same time as shown in FIG. 8, and can have only partially overlapping or non-overlapping synchronization times.

FIG. 9 illustrates a structure of subtitle and video mapping information for the multi-story video data recorded to have multiple paths for reproduction, shown in FIG. 8, according to an embodiment of the present invention. As shown, the subtitle and video mapping information specifies a linkage relation between text-based subtitles and a series of video data. The subtitle and video mapping information includes subtitle language indication information specifying languages of subtitles, title indication information specifying titles of the subtitles displayed on a screen, and location information specifying locations of subtitles defined in the subtitle and video mapping information for video data A through C, individually. As shown, the subtitle and video mapping data indication information structure includes a language code and subtitle information indication for use in formatting and displaying the subtitle for each video data A, B, C.

Specifically, for video data C, a subtitle information structure C indicates a first phrase for display at sync time: 00:00 and a second phrase for display at sync time 00:05 during reproduction of video data C. For video data A, which follows video data C as one of two stories A, B, a subtitle information structure A indicates a first phrase for display at sync time: 00:10 and a second phrase for display at sync time 00:15 during reproduction of video data A. For video data B, which follows video data C as one of two stories A, B, a subtitle information structure B indicates a first phrase for display at sync time: 00:10 and a second phrase for display at sync time 00:15 during reproduction of video data B. As shown, the first and second phrases in subtitle information structure B is not the same as in subtitle information structure A. In this way, different subtitles are associated with the reproduction of the video data itself, which allows the user to receive subtitles associated with specific scenes regardless of the timing of the display.

FIG. 10 illustrates a structure of multi-lingual subtitle indication information that contains subtitle and video mapping information categorized by languages so as to provide multi-lingual text-based subtitles, according to an embodiment of the present invention. Referring to FIG. 10, based on multi-story video data recorded to have multiple paths A through C for reproduction stored in an information storage medium, multi-lingual subtitle indication information supporting multiple languages and subtitle and video mapping information regarding linkage the relation among respective text-based subtitles and a series of video data are combined. If the multi-lingual subtitle indication information is obtained from a site on the Internet, the address of the site is stored in the information storage medium. If the multi-lingual subtitle indication information is stored in a portion of an information storage medium, information regarding the position of the information storage medium containing this information is stored in the information storage medium. The information regarding the position of the information storage medium may be one of the commands for subtitle processing and the location information regarding subtitles, mentioned with reference to FIGS. 5 and 6, respectively.

The shown multi-lingual subtitle indication information contains information regarding languages of the subtitle and video mapping information, information regarding titles of the subtitle and video mapping information displayed on a screen, and information of the subtitle and video mapping information. The structure of the subtitle and video mapping information is substantially that illustrated in FIG. 9 with respect to an English subtitle.

FIG. 11 illustrates a structure of subtitle information indication shown in FIG. 9 or FIG. 10 according to an embodiment of the present invention. Referring to FIG. 11, the subtitle information indication includes reference synchronization offset information regarding absolute reference starting point of time when subtitles are displayed; synchronization time information that indicates subtitle synchronization time for subtitle synchronization (i.e., information regarding time elapsed from a reference synchronization offset); and text data information regarding the subtitles. The subtitle data information contains at least one reference offset information and at least one synchronization time information for displaying the corresponding subtitle text in the shown embodiment.

The multi-lingual subtitle indication information, the subtitle and video mapping information, and the subtitle data information may either be separately recorded in files units or information storage units or be combined and recorded in a file or an information storage unit, and read and parsed by a reproducing apparatus.

A reproducing apparatus according to the present invention is applicable to a reproducing apparatus capable of reproducing multi-story video data recorded in a DVD-video format or in a Blu-ray video format. However, it is understood that other formats can be used, both optical and/or magnetic, and can be used with read only, write once, and/or rewritable media.

Also, the present invention can be embodied as a computer readable code stored in at least one computer readable medium for use on one or more computers. Here, the computer readable medium may be any recording apparatus capable of storing data that can be read by a computer system, e.g., a read-only memory (ROM), a random access memory (RAM), a compact disc (CD)-ROM, a magnetic tape, a floppy disk, an optical data storage device, and so on. Also, the computer readable medium may be a carrier wave that transmits data via the Internet, for example. The computer readable recording medium can be distributed among computer systems that are interconnected through a network, and the present invention may be stored and implemented as a computer readable code in the distributed system.

As described above, according to the present invention, it is possible to download subtitle data information from an information storage medium or via the Internet according to user interface and reproduce text-based subtitles for multi-story video data recorded to have multiple paths for reproduction from the information storage medium, using a reproducing apparatus. However, it is understood that, while text based subtitles are disclosed by way of example, additional information, such as images and/or audio, can be stored or referenced in instead of or in addition to the text based subtitles. Moreover, it is understood that aspects of the invention can be applied to other types of data beyond video data.

Also, the present invention is applicable to reproduction of multi-story video, such as DVD-video or Blu-ray video, that are recorded to have multiple paths for reproduction from an information storage medium so that its video stream data contents can be differently reproduced via user interface.

Further, the present invention is applicable to reproduction of a video data stream with a reproduction structure allowing a movie manufacturer to provide subtitles via the Internet and a reproducing apparatus to read and reproduce the subtitles via the Internet, thereby enabling change of video contents during reproduction.

While this invention has been particularly shown and described with reference to exemplary embodiments thereof, it will be understood by those skilled in the art that various changes in form and details may be made therein without departing from the spirit and scope of the invention as defined by the appended claims and their equivalents.

1. An information storage medium that stores multi-story video data recorded to have multiple paths for reproduction by a recording and/or reproducing apparatus, comprising:
subtitle information for multi-story video linked to the multi-story video data corresponding to the multiple paths for reproduction, wherein, prior to reproduction of the multi-story video data, the apparatus reads the subtitle information at a location specified in a location information determined by a user so as to allow the user to select subtitles that are to be reproduced in the multi-story video data.

2. The information storage medium of claim 1, wherein the subtitle information comprises multi-lingual subtitle indication information supporting multiple languages, and/or subtitle and video mapping information specifying a linkage relation between text-based subtitles and the multi-story video data for the respective multiple paths for reproduction and comprises subtitle data information for each path.

3. The information storage medium of claim 2, wherein the multi-lingual subtitle indication information comprises language indication information regarding languages of the subtitle and video mapping information, title indication information regarding titles of the subtitle and video mapping information displayed on a screen, and/or indication information regarding the subtitle and video mapping information.

4. The information storage medium of claim 2, wherein the subtitle and video mapping information comprises subtitle language information, title indication information regarding titles of subtitles displayed on the screen, and/or subtitle location indication information regarding the location of the subtitles that are to be reproduced.

5. The information storage medium of claim 2, wherein the subtitle data information comprises at least one reference offset information for displaying a corresponding subtitle text.

6. The information storage medium of claim 5, wherein the subtitle data information further comprises at least one synchronization time information for displaying a corresponding subtitle text.

7. The information storage medium of claim 6, wherein the subtitle data information further comprises synchronization time information for synchronizing the subtitles, using information regarding time elapsed from the reference offset information for displaying a corresponding subtitle text.

8. The information storage medium of claim 2, wherein the multi-lingual subtitle indication information, the subtitle data information, and the subtitle and video mapping information are separately stored in file units and/or information storage units.

9. The information storage medium of claim 2, wherein the multi-lingual subtitle indication information, the subtitle data information, and the subtitle and video mapping information are combined and stored within one of a file unit and an information storage unit.

10. An information storage medium that stores multi-story video data recorded to have multiple paths for reproduction by a recording and/or reproducing apparatus, comprising:
commands used by the apparatus for subtitle processing, the commands instructing the apparatus to perform a selection of a language of subtitles corresponding to the multi-story video data, and, during reproduction of the multi-story video data, the apparatus executes the commands to read subtitle information and allow a user to select subtitles in order to perform the selection.

11. The information storage medium of claim 10, wherein the subtitle information comprises of multi-lingual subtitle indication information supporting multiple languages, and/or subtitle and video mapping information specifying a linkage relation between subtitles and the multi-story video data for the respective multiple paths for reproduction, and comprises subtitle data information for each path.

12. The information storage medium of claim 11, wherein the multi-lingual subtitle indication information comprises language indication information regarding languages of the subtitle and video mapping information, title indication information regarding titles of the subtitle and video mapping information displayed on a screen, and/or indication information regarding the subtitle and video mapping information.

13. The information storage medium of claim 11, wherein the subtitle and video mapping information comprises subtitle language information, title indication information regarding titles of subtitles displayed on the screen, and/or subtitle location indication information regarding the location of the subtitles that are to be reproduced.

14. The information storage medium of claim 11, wherein the subtitle data information comprises at least one reference offset information for use by the apparatus in displaying a corresponding subtitle text.

15. The information storage medium of claim 14, wherein the subtitle data information further comprises at least one synchronization time information for displaying a corresponding subtitle text.

16. The information storage medium of claim 15, wherein the subtitle data information further comprises synchronization time information for synchronizing the subtitles, using information regarding time elapsed from the reference offset information for displaying a corresponding subtitle text.

17. The information storage medium of claim 11, wherein the multi-lingual subtitle indication information, the subtitle data information, and the subtitle and video mapping information are separately stored in one of file units and information storage units.

18. The information storage medium of claim 11, wherein the multi-lingual subtitle indication information, the subtitle data information, and the subtitle and video mapping information are combined and stored within a file unit and/or an information storage unit.

19. An information storage medium comprising multi-story video data recorded to have multiple paths for reproduction by a recording and/or reproducing apparatus, and subtitle information and/or location information of the subtitle information linked to the multi-story video data corresponding to ones of the multiple paths for use in reproduction by the apparatus.

20. The information storage medium of claim 19, wherein a user is allowed to select a subtitle language from a menu displayed by the apparatus based on the location information of the subtitle information.

21. The information storage medium of claim 19, wherein a subtitle language for each path is automatically selected as predetermined by the user and output during reproduction of the multi-story video data.

22. The information storage medium of claim 19, wherein the subtitle information comprises multi-lingual subtitle indication information supporting multiple languages, and/or subtitle and video mapping information specifying a linkage relation between the text-based subtitles and the multi-story video data for the respective multiple paths for reproduction and comprises subtitle data information for each path.

23. The information storage medium of claim 22, wherein the multi-lingual subtitle indication information comprises language indication information regarding languages of the subtitle and video mapping information, title indication information regarding titles of the subtitle and video mapping information displayed on a screen, and/or indication information regarding the subtitle and video mapping information.

24. The information storage medium of claim 22, wherein the subtitle and video mapping information comprises subtitle language information, title indication information regarding titles of subtitles displayed on the screen, and/or subtitle location indication information regarding a location of the subtitles that are to be reproduced.

25. The information storage medium of claim 22, wherein the subtitle data information comprises at least one reference offset information for displaying a corresponding subtitle text.

26. The information storage medium of claim 25, wherein the subtitle data information further comprises at least one synchronization time information for displaying a corresponding subtitle text.

27. The information storage medium of claim 26, wherein the subtitle data information further comprises synchronization time information for synchronizing the subtitles, using information regarding time elapsed from the reference offset information for displaying a corresponding subtitle text.

28. The information storage medium of claim 22, wherein the multi-lingual subtitle indication information, the subtitle data information, and the subtitle and video mapping information are separately stored in one of file units and information storage units.

29. The information storage medium of claim 22, wherein the multi-lingual subtitle indication information, the subtitle data information, and the subtitle and video mapping information are combined and stored within one of a file unit and an information storage unit.

30. An information storage medium that stores multi-story video data recorded to have multiple paths for reproduction by a recording and/or reproducing apparatus, comprising:
multi-lingual subtitle indication information supporting multiple languages;
subtitle data information including text-based subtitles for each of the multiple languages;
subtitle and video mapping information specifying linkage relations between the text-based subtitles and corresponding paths of multi-story video data corresponding to the multiple paths for reproduction; and
a command used by the apparatus for instructing location information of the multi-lingual subtitle indication information to be parsed so as to read the multi-lingual subtitle indication information and the subtitle and video mapping information.

31. The information storage medium of claim 30, further comprising command data instructing the multi-lingual subtitle indication information to be parsed, a user to select subtitles, the subtitle and video mapping information related to the selected subtitles to be parsed, and the selected subtitles to be output.

32. The information storage medium of claim 30, further comprising command data instructing the multi-lingual subtitle indication information to be parsed so as to obtain subtitle selection information, the subtitle and video mapping information to be selected based on the subtitle selection information, and the subtitle data information to be read and output.

33. The information storage medium of claim 30, further comprising command data instructing the selected subtitle data to be mapped to the video data, and the subtitle data information to be read and output.

34. The information storage medium of claim 30, wherein when the multi-lingual subtitle indication information is stored in a site on the Internet, the video data further comprises an address of the site.

35. The information storage medium of claim 30, wherein when the multi-lingual subtitle indication information is stored in a portion of the information storage medium, the video further comprises information regarding a location of the portion.

36. The information storage medium of claim 30, wherein the multi-lingual subtitle indication information comprises language indication information regarding languages of the subtitle and video mapping information, title indication information regarding titles of the subtitle and video mapping information displayed on a screen, and/or indication information regarding the subtitle and video mapping information.

37. The information storage medium of claim 30, wherein the subtitle and video mapping information comprises subtitle language information, title indication information regarding titles of subtitles displayed by the apparatus on a screen, and/or subtitle location indication information regarding a location of the subtitles that are to be reproduced by the apparatus.

38. The information storage medium of claim 30, wherein the subtitle data information comprises at least one reference offset information for use by the apparatus in displaying a corresponding subtitle text.

39. The information storage medium of claim 30, wherein the subtitle data information further comprises at least one synchronization time information for use by the apparatus in displaying a corresponding subtitle text.

40. The information storage medium of claim 39, wherein the subtitle data information further comprises synchronization time information for synchronizing the subtitles, using information regarding time elapsed from the reference offset information for use by the apparatus in displaying a corresponding subtitle text.

41. The information storage medium of claim 30, wherein the multi-lingual subtitle indication information, the subtitle data information, and the subtitle and video mapping information are separately stored in one of file units and information storage units.

42. The information storage medium of claim 30, wherein the multi-lingual subtitle indication information, the subtitle data information, and the subtitle and video mapping information are combined and stored within one of a file unit and an information storage unit.

43. A method of reproducing subtitle data linked to video data using a reproducing apparatus that reproduces multi-story video data recorded to have multiple paths for reproduction from an information storage medium, the method comprising:
reading subtitle information at a location prior to reproduction of the corresponding path of the multi-story video data, information of the location being provided by a user; and
allowing the user to select desired subtitles to be reproduced in each of the stories of the video data based on the read subtitle information.

44. The method of claim 43, wherein the information regarding the location is input in the reproducing apparatus by the user before reproduction of the multi-story video data.

45. The method of claim 43, wherein the information regarding the location is input by the user whenever reproducing the multi-story video data from the information storage medium.

46. The method of claim 43, wherein the subtitle information comprises multi-lingual subtitle indication information supporting multiple languages, subtitle data information, and/or video and video data mapping information specifying a linkage relation between text-based subtitles and multi-story video data corresponding to the multiple paths for reproduction.

47. A method of reproducing subtitle data linked to video data, using a reproducing apparatus that reproduces multi-story video data recorded to have multiple paths for reproduction from an information storage medium that further stores commands for subtitle processing, the method comprising:
reading subtitle information when the commands are executed during reproduction of corresponding paths of the multi-story video data; and
allowing a user to select subtitles in each of the stories of the video data based on the read subtitle information.

48. The method of claim 47, wherein the subtitle information comprises multi-lingual subtitle indication information supporting multiple languages, subtitle data information, and/or video and video data mapping information specifying a linkage relation between text-based subtitles and multi-story video data corresponding to the multiple paths for reproduction.

49. A method of reproducing subtitle data linked to video data, using a reproducing apparatus that reproduces multi-story video data with multiple paths for reproduction from an information storage medium that further stores subtitle information and/or location information of the subtitle information, the method comprising:
detecting a location where the subtitle information is stored, and reading and parsing the subtitle information in the reproducing apparatus for each corresponding path; and
selecting a subtitle language based on the parsed subtitle information.

50. The method of claim 49, wherein the subtitle information comprises multi-lingual subtitle indication information supporting multiple languages, subtitle data information, and/or video and video data mapping information specifying a linkage relation between text-based subtitles and multi-story video data corresponding to the multiple paths for reproduction.

51. The method of claim 49, wherein the selecting of the subtitle language comprises the reproducing apparatus generating a menu for selection of subtitles based on the parsed subtitle data information and allowing a user to select a subtitle language and output the subtitles in the selected subtitle language.

52. The method of claim 49, wherein the selecting of the subtitle language comprises allowing the subtitle language to be automatically selected as predetermined by the user, based on the parsed subtitle data information.

53. A method of reproducing subtitle data linked to video data stored in an information storage medium that stores multi-story video data recorded to have multiple paths for reproduction, the method comprising:
reading multi-lingual subtitle indication information and analyzing types of languages and applications of subtitles for each of the paths;
parsing subtitle and video mapping information that specifies a linkage relation between the subtitles and the video data, and reading subtitle data information that is to be reproduced; and
outputting the subtitle data information corresponding to the video data during reproduction of the video data.

54. The method of claim 53, wherein the reading of the multi-lingual subtitle indication information further comprises executing a command that instructs location information of the multi-lingual subtitle indication information to be parsed and the multi-lingual subtitle indication information and the subtitle and video mapping information to be read in a reproducing apparatus.

55. The method of claim 53, wherein the reading of the subtitle data further comprises executing a command that instructs the multi-lingual subtitle indication information to be parsed, a user to select subtitles, subtitle and video mapping information related to the selected subtitles to be parsed, and the selected subtitles to be output.

56. The method of claim 53, wherein the reading of the subtitle data further comprises executing a command that instructs the multi-lingual subtitle indication information to be parsed so as to obtain subtitle selection information, subtitle and video mapping information to be selected based on the subtitle selection information, and subtitle data to be read and output.

57. The method of claim 53, wherein the outputting of the subtitles further comprises executing a command that instructs the subtitle data to be mapped to the video data and the subtitle data to be read and output.

58. An apparatus for recording and/or reproducing multi-story video data recorded to have multiple paths for reproduction from an information storage medium, the apparatus comprising:
a reader which reads audio/video (AV) data having multiple paths and subtitle and video mapping information including text-based subtitle data information, multi-lingual subtitle indication information, and/or downloaded font data from the information storage medium;
a decoder which decodes the read AV data to output a moving image;
a subtitle processor which processes a language selection file related to the subtitle data information and subtitle and video mapping information, and performs screen rendering;
a menu generator which generates a menu according to command data read by the reader or as predetermined; and
a blender which combines the moving image output from the decoder, the subtitle data output from the subtitle processor for path of output moving image, and/or the menu generated by the menu generator, and displays a result of combination on a display device.

59. The apparatus of claim 58, further comprising:
a buffer which buffers data exchanged among the reader, the decoder, and the subtitle processor, and which stores the downloaded font data;
a storage unit storing resident font data stored as a default; and
a controller which controls selection of subtitles made in a desired language from the menu generated by the menu generator via user interface, and controlling operations of the reader, the decoder, the subtitle processor, the menu generator, the blender, the buffer, and the storage unit.

60. The apparatus of claim 58, wherein before reproduction of the multi-story video data, respective subtitle data information for the paths are read at corresponding locations, information of the locations are provided by a user, and the user is allowed to select subtitles that are to be output from the menu based on the read subtitle data information.

61. The apparatus of claim 60, wherein the location information is input in the reproducing apparatus by the user before reproduction of the multi-story video data.

62. The apparatus of claim 60, wherein the location information is input by the user whenever the multi-story video data is reproduced.

63. The apparatus of claim 58, wherein:
a command that instructs the menu to be generated is stored as command data in the information storage medium, and
the user is allowed to select subtitles from the menu generated by the menu generator when a command for subtitle processing read by the reader is executed during reproduction of the multi-story video data.

64. The apparatus of claim 58, wherein:
one of the subtitle data information and location information of the subtitle data information is stored in the information storage medium,
the location information is parsed to determine a location of the subtitle data information detected using the reader and the subtitle data information is read at the location and parsed in the reproducing apparatus,
the user is requested to select a subtitle language from the menu generated by the menu generator, according to a sequence input by the user or stored in the information storage medium or when a command stored in the information storage medium is executed, and
the subtitle data information is output in the selected subtitle language.

65. The apparatus of claim 58, wherein
one of the subtitle information and the location information of the subtitle information are stored in the information storage medium,
the one of the subtitle information and the location information is parsed to determine a location of the subtitle data and the subtitle information is read at the location and parsed using the reader, and
a subtitle language is automatically selected as predetermined by the user.

66. An information storage medium that stores caption information to be reproduced with video data having linked first and second video elements for reproduction by a recording and/or reproducing apparatus, comprising:
first subtitle information which indicates to the apparatus a correspondence between the first video element and a first subtitle to be reproduced with the first video element; and
second subtitle information which indicates to the apparatus a correspondence between the second video element and a second subtitle to be reproduced with the second video element.

67. The information storage medium of claim 66, wherein the first and second video elements comprise alternate scenes reproduced at a common synchronized time, the first subtitle comprises a first caption for use in the first video element, and the second subtitle comprises a second caption other than the first caption for use in the second video element.

68. The information storage medium of claim 66, wherein the first and second subtitles comprises text written in first and second languages, and the information storage medium further comprises subtitle language indication information which comprises a first selection for the first subtitle to be displayed and is selectable between the first language and the second language other than the first language, and a second selection for the second subtitle to be displayed and is selectable between the first language and the second language.

69. Information storage media that store video data and caption data for reproduction by a recording and/or reproducing apparatus, comprising:
first and second video elements;
linking information which allows reproduction of the first and second video elements sequentially and allows reproduction of the first and second video elements individually;
first subtitle information which indicates to the apparatus a first subtitle to be reproduced with the first video element;
second subtitle information which indicates to the apparatus a second subtitle to be reproduced with the second video element; and
caption linking information which indicates a location of the first and second subtitle information for use in reproducing the first and second subtitles with the first and second video elements, the first and second subtitle information being stored on a medium other than a medium which stores the caption linking information.

70. The information storage media of claim 69, wherein the first and second subtitle information is read by the apparatus prior to reproduction of the video data.

71. An information storage medium that stores video data for reproduction by a recording and/or reproducing apparatus, comprising:
first and second video elements;
linking information which allows reproduction of the first and second video elements sequentially and allows reproduction of the first and second video elements individually; and
a command which, prior to allowing a selection of a subtitle to be displayed by the apparatus during reproduction of the first and/or second video elements, instructs the apparatus to retrieve from another medium:
first and second subtitles, and
caption linking information comprising first subtitle information which indicates to the apparatus a first subtitle to be reproduced with the first video element, and second subtitle information which indicates to the apparatus a second subtitle to be reproduced with the second video element.

72. The information storage medium of claim 71, wherein the command comprises an address of the another medium across a network.

73. The information storage medium of claim 71, wherein the address of the another medium comprises a Uniform Resource Identifier (URI).

74. The information storage medium of claim 71, further comprising a menu command which instructs a menu to be displayed to allow a selection for the subtitle as between a first language and a second language other than the first language, the menu command being executed by the apparatus after retrieval of the first and second subtitle information.

75. The information storage medium of claim 71, further comprising a parse command which instructs the apparatus to parse and display a pre-selected language for the subtitle selected as between a first language and a second language other than the first language, the parse command being executed by the apparatus after retrieval of the first and second subtitle information.

76. The information storage medium of claim 75, wherein the pre-selected language is selected without the apparatus displaying a menu.

77. The information storage medium of claim 75, wherein the pre-selected language is a default language set in the apparatus.

78. An apparatus for recording and/or reproducing multi-story video data recorded to have multiple paths for reproduction from an information storage medium, the apparatus comprising:
a reader which reads a subtitle retrieval command and the video data including linked video elements from the information storage medium;
a decoder which decodes the read video data to output a moving image;
a subtitle processor which performs screen rendering for subtitles to be displayed;
a blender which combines the moving image output from the decoder, and the subtitles output from the subtitle processor, and outputs a combined result to be displayed on a display device; and
a controller which uses the subtitle retrieval command to retrieve subtitle and video mapping information including subtitle data information including the subtitles linked to the corresponding video elements, and to use the subtitle and video mapping information in order to control the blender to combine each output video element and the corresponding subtitle.
